(19) United States
(12) Patent Application Publication
(10) Pub. No.: US 2025/0230063 A1
(43) Pub. Date: Jul. 17, 2025

(54) Living Waters Renewable Desalination

(71) Applicant: Kurt Grossman, Newport Beach, CA (US)

(72) Inventor: Kurt Grossman, Newport Beach, CA (US)

(21) Appl. No.: 19/095,574

(22) Filed: Mar. 31, 2025

(51) Int. Cl. C02F 1/04; C02F 1/44; C02F 103/08

(52) U.S. Cl. CPC C02F 1/041; C02F 1/442; C02F 2103/08; C02F 2201/005; C02F 2209/03; C02F 2301/066; C02F 2303/10

(57) ABSTRACT

The invention produces pure fluids and transports fluids using renewable energy integrated into the purification process and maximize energy efficiency by utilizing simple machines, gravity, and buoyancy combined with different proven state of the art water purification and membrane systems.

The invention requires no real estate in some embodiments and in other embodiments can also locate in very dense populated areas on land to provide decentralized services.

### CROSS-REFERENCE TO RELATED APPLICATIONS

### Related Applications

The present application claims the benefit of U.S. Provisional Application Ser. No. 61/226,290, which was filed on Jul. 17, 2009, U.S. patent application Ser. No. 12/690,060, which was filed on Jan. 19, 2010, U.S. Provisional Application Ser. No. 61/434,442, which was filed on Jan. 20, 2011, U.S. Provisional Application Ser. No. 61/843,824, which was filed on Jul. 8, 2013, U.S. Provisional Application Ser. No. 61/856,044, which was filed on Jul. 19, 2013, U.S. Provisional Application Ser. No. 61/863,384, which was filed on Aug. 7, 2013, EFS ID 19512465 and PCT/US14/45635, which was filed on Jul. 8, 2014, and EFS ID 19797740, U.S. Provisional Application Ser. No. 62/034,160, which was filed on Aug. 7, 2014, the entirety of which is hereby incorporated by reference.

### BACKGROUND OF THE INVENTION

### Field of the Invention

This invention relates to fluid pumping and fluid treatment especially water and desalination systems using renewable energy as the primary source of energy.

### Background

Water is essential to life. Water covers more than seventy percent of the earth surface. Water is the most important fluid. The Hydrologic Cycle can be described as; evaporation caused by buoyancy heating water with energy from the sun, condensation caused by the cool temperature of higher altitude, and precipitation caused by gravity causing water to fall back down on the earth on land and gravity causing the water to ultimately flow back down into lakes, rivers, streams, and into the ocean.

With the population of the earth well over six billion people and most of the people living in large cities with very dense populations water management can no longer be handled by a loving God dropping rain and snow every once in a while.

Mankind desperately needs to manage water in a much more aggressive manner. Technology advancements in the field of water treatment, water management, water purification, and most specifically desalination have tremendous geopolitical implications.

All of the processes and transportation of water consumes a tremendous amount of energy globally! Now that the issues of Climate Change, the disappearing reserves for all kinds of fossil fuels, the political implications of importing fuels that support a nation's ability to defend itself, and the concern for clean air and environmental protection in general have become so important there is a heightened interest in alternative power sources.

The “Water Nexus” is a term that describes the energy and water connection: how much energy is used for providing, treating, and moving water so that people can drink, farm, clean, bathe, recreation, and for industrial purposes.

### SUMMARY OF THE INVENTION

Removing impurities from fluids such as wastewater, mining runoff, and desalination are growing in acceptance and use everywhere in the world as a new form of getting much needed water and insuring that pollution does not reenter the aquifers or hydrologic systems. On the other hand these technologies and industries rolling out projects face strong opposition from environmental groups concerned about the large amounts of energy required and the potential for damage to marine ecosystems. Renewable energy powered desalination has enormous support but small project demonstrations show that it is very expensive. Many new projects have been stalled for years.

The Living Water Renewable Energy Desalination invention is a combination of a machine and a process.

The Living Water Renewable Energy Desalination machine comprises a structure that works in a fluid body that has impurities like the ocean or is in a complex on land that receives large amounts of fluid containing dissolved solids and houses fluid and gas processing machines inside.

The Living Water Renewable Energy Desalination machine is also comprised of conduit connected to machines that move fluids.

The Living Water Renewable Energy Desalination invention can take advantage of a conduit fluid delivery process that uses buoyancy in buoyant objects to cause the upward floating to deliver the fluid without external power. The invention uses gates and bypasses to intermediate reservoirs to enable the system to maintain a controlled isolated pressure when the system is inside underneath a fluid body or outside of a fluid body on land going up a mountain, hill, or any incline.

The Living Water Renewable Energy Desalination invention integrates reliable components the navies of the world, commercial marine operations, and the offshore industry have used for decades such as corrosive resistant materials Ultra High Molecular Weight (“UHMW”) and strong and durable High Performance Concrete (“HPC”).

### BRIEF DESCRIPTION OF THE DRAWINGS

FIG. 1 is a high level overview showing the fluid states and the primary embodiment of a structure submerged in an impure fluid.

FIG. 2 is a cutaway view of a few levels of a structure underwater

FIG. 3 is another embodiment of a structure on land

FIG. 4 is an exploded view of some primary equipment and an embodiment of a gravity hydropower plant

FIG. 5 is an exploded view of an air compressor heat recovery schematic applied to fluid purification

FIG. 6 illustrates brine management

FIG. 7 is another embodiment of a structure with integrated gravity power

FIG. 8 is an overview of the brine disposal and impingement and entrainment environmental protection

FIG. 9 Is an embodiment of a conduit system using both buoyancy and gravity for power

FIG. 10 Is an embodiment of a conduit system using valves for pressure management

### DETAILED DESCRIPTION

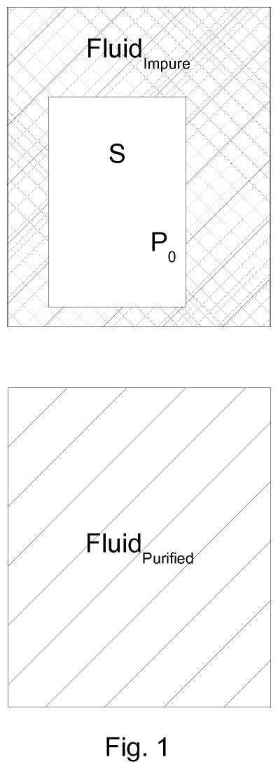

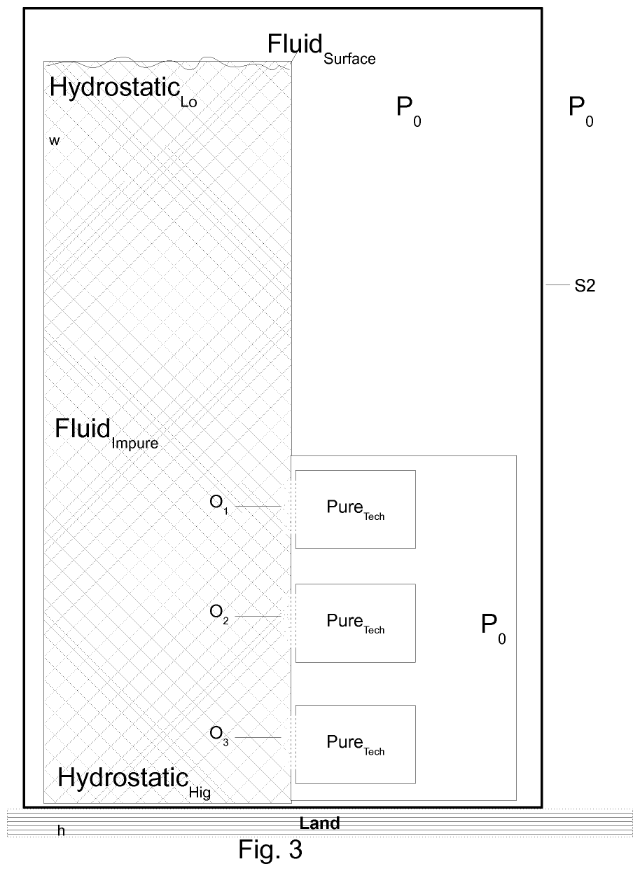

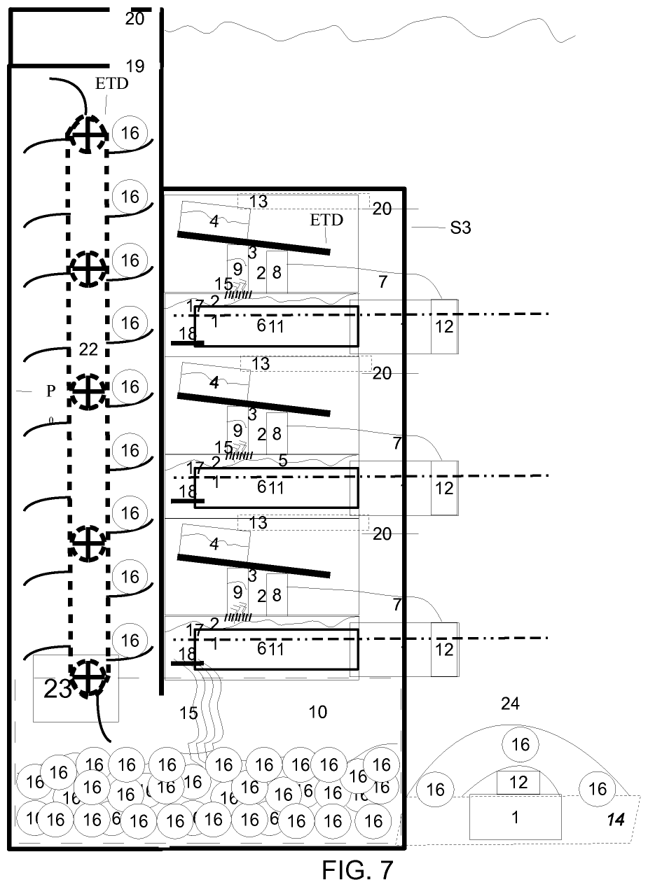

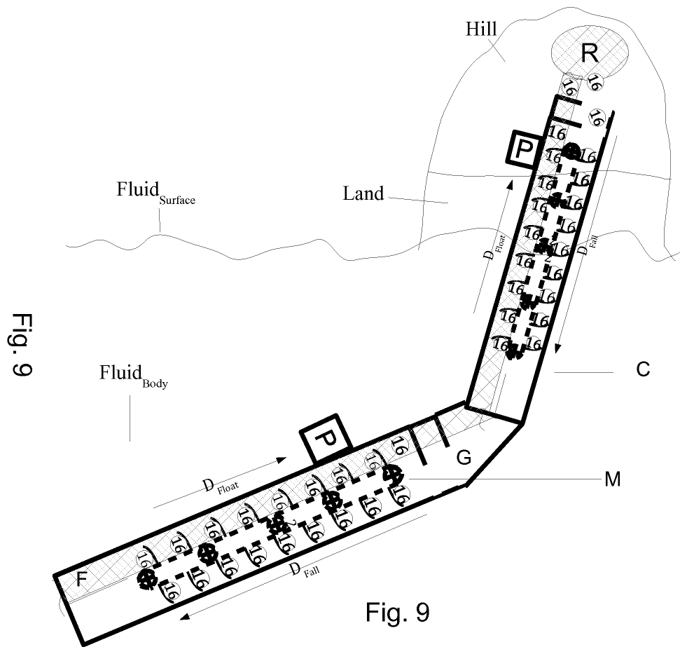

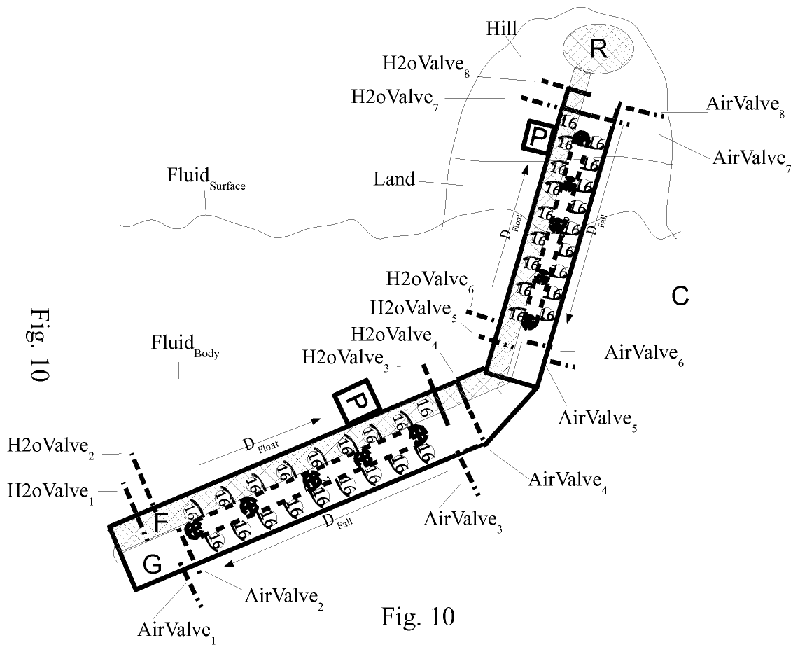

A structure S FIG. 1, structure S2 FIG. 3, or structure S3 FIG. 7 submerged in an ocean or any fluid containing dissolved solids Fluid_{Impure} or in any fluid body Fluid_{Body} FIG. 9 and FIG. 10 maintains an internal normal sea level pressure P₀ removes the dissolved solids using renewable energy supplied by hydrostatic pressure and gravity to deliver drinking water or purified water Fluid_{purified} suitable for beneficial use.

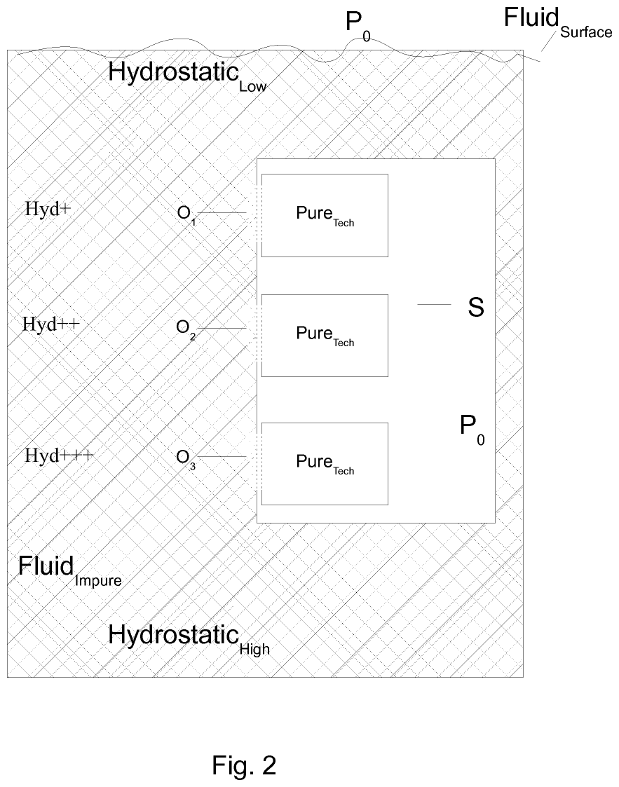

The structure S FIG. 2 contains a fluid purification technology Pure_{Tech} like reverse osmosis and multi-stage flash desalination equipment with for example means for entry O₁ of a fluid containing dissolved solids Fluid_{Impure} that uses lower hydrostatic pressure Hydrostatic_{Low} closer to surface level Fluid_{surface} and higher hydrostatic pressure Hydrostatic_{High} so that means for entry O₁ has hydrostatic pressure Hyd+, means for entry O₂ Hyd++, and means for entry O₃ Hyd+++as an energy source that increases the energy efficiency of the fluid purification technology Pure_{Tech}.

In another embodiment FIG. 3 structure S2 is set on land and the fluid containing dissolved solids Fluid_{Impure} might also be sewage or some industrial chemical.

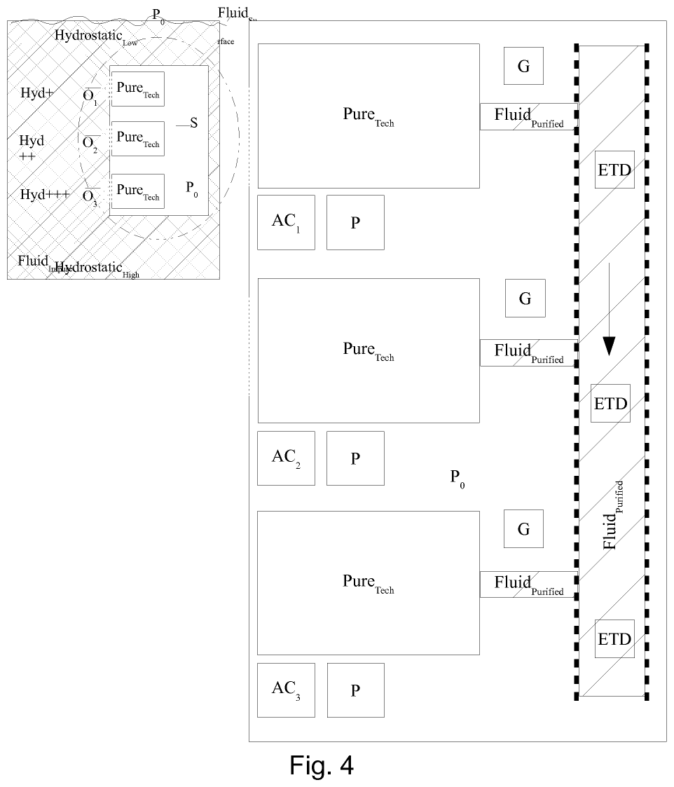

In FIG. 4 an example of the principal standard machinery is depicted in an exploded view with pumps P, air compressors AC, generators G and very simple and common mechanical energy transfer devices such as levers, turbines, or pulleys ETD can all be incorporated to use the force of gravity and the mass of the purified water Fluid_{purified}-gravitational potential energy after discharge from the fluid purification technology Pure_{Tech} to convert into mechanical energy to drive pumps P, spin generators G, and rotate air compressors AC. FIG. 4 is not intended in any way to limit the invention and cogeneration of energy to the purified water Fluid_{purified} or any other purified liquid is also claimed. Although not depicted in FIG. 4 dissolved solids and highly concentrated impure fluids are mass that can be used to produce additional energy.

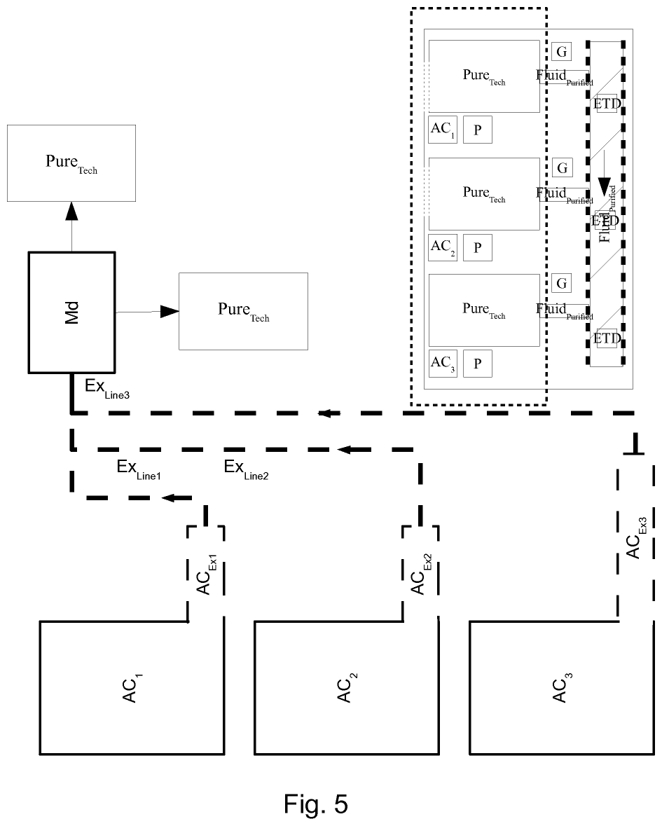

FIG. 5 cutaway from FIG. 4 illustrates air compressors AC₁, AC₂, and AC₃ exhaust discharges AC_{Ex1}, AC_{Ex2}, and AC_{Ex3} deliver gas typically over 200° F. temperature hot gas via air compressor exhaust lines EX_{Line1}, EX_{Line1}, and EX_{Line3} into an insulated manifold Md that distributes the heat to be applied especially but not limited to Multi-stage Flash, Vapor Compression, and Multi-Effect Flash fluid purification technologies Pure_{Tech} to remove or reduce energy and power consumption.

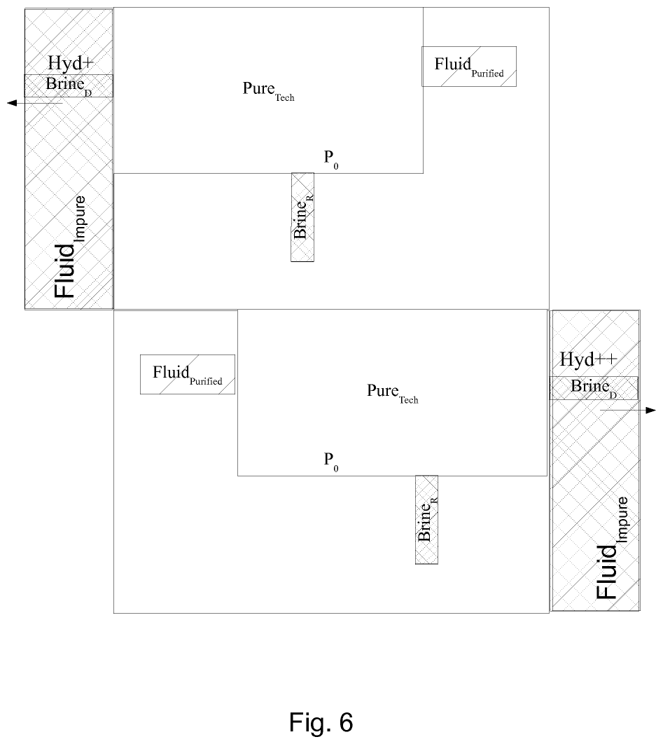

In FIG. 6 fluid purification technologies Pure_{Tech} filtration and separation technology using evaporation, membrane filtration, nano filtration, bacterial filtration, and similar technologies are positioned to send the streams of fluid with higher concentrations of dissolved solids for further processing Brine_{R} or immediate discharge Brine_{D} back into the body of water at varying depths such as Hyd+ and Hyd++ and in different directions so that the concentrated streams of fluid are diluted prior to being discharged back into the body of water so that the stream of fluid easily dilutes back into normal concentration leaving the ambient ecosystem intact without harm;

FIG. 7 shows another embodiment structure S3 where the buoyant objects 16 in air are heavy and fall by the force of gravity engaging different mechanical energy transfer devices ETD in an air space with internal normal sea level pressure P₀.

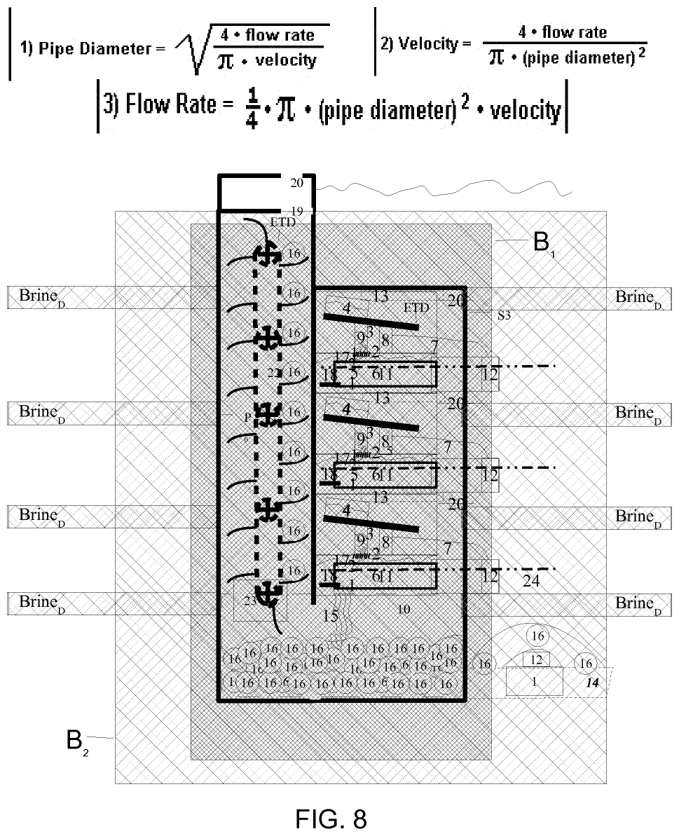

FIG. 8 shows the structure submerged in an ocean or sea with living ecosystems will be completely enveloped in a perimeter barrier system B₁ surrounds all of the different embodiments of structures in a geometrical configuration so that there is sufficient volume of water coming into all of the inlets but living organisms and large particles or debris are kept out of the system. A more outer perimeter barrier system B₂ allows the flow of seawater inside the barrier system with a velocity and suction equal to or less than the ambient natural flow and the barrier system restricts and filters large organisms and particulate matter without trapping living organisms against the barrier system. The diluted brine Brine_{D} piping extends outside of both perimeter barrier system B₁ and perimeter barrier system B₂ perimeters to distribute diluted brine outside of the perimeters at different depths and directions far away from intake systems. The combination of the barriers create a very robust insurance that water life will never be allowed near machinery and the geometrical configuration takes into account the amount of suction that is created that might trap organisms.

The formulas for fluid flow 1), 2), and 3) in FIG. 8 show that creating a single path for water to flow inside on the top and the bottom of the perimeter barrier systems produces a suction velocity of two miles per hour that is much less suction and velocity than the currents flowing around the structure and perimeters.

A conduit C FIG. 9 is placed below the surface level Fluid_{surface} in a fluid body Fluid_{Body} normally the ocean and can equally be located on land comprising two or more paths with one path containing fluid F and another path containing a gas G that is normally air with one end lower than the other end has machinery M that transfers buoyant energy when a buoyant object 16 floats up D_{Float} and captures energy from gravity as the buoyant object 16 falls down D_{Fall} to drive pump P or to power other important machinery or to generate electricity or other uses that will become apparent pumps fluid onto Land up D_{Float} a Hill, incline, mountain, or any elevated location to a reservoir R or other end destination.

Fluid F may remain stationary as a platform to float the buoyant objects 16 if an additional pipeline of fluid is positioned next to the conduit or fluid F may be pumped up D_{Float} at the discretion of the operator.

The buoyant objects 16 return into conduit C inside path G to fall while machinery M transfers gravity energy into mechanical kinetic energy to drive the pumps P or the energy can be used as needed.

Hydrostatic pressure of fluids is dependent on the fluid density and height of the column. Illustrated FIG. 10 is a partial view containing only two connected sections of a much longer conduit C making a transition from the ocean Fluid_{Body} onto Land up a Hill into reservoir R.

To control the hydrostatic pressure in path F and pneumatic pressure in path G a series of valves operate independently in a coordinated manner. The embodiment in FIG. 10 is for illustrative purposes only and is not intended to limit the scope of the invention in any way. The valves open and close independently but in a coordinated manner eliminate pressure transferring arbitrarily from a section of the conduit C to another section of the conduit C. The valves eliminate potentially catastrophic failure due to a pressure buildup if the conduit C has a very large vertical distance from beginning to end. The valves also enable higher gas pressure to be inside of lower sections of conduit C so that the internal pressure and the external pressure do not put unnecessary stress on the conduit C material.

In FIG. 10 path G valves are open and closed; AirValve₁ is open, is AirValve₂ is closed, AirValve₃ is open, AirValve₄ is closed, AirValve₅ is open, is AirValve₆ is closed, AirValve₇ is closed, and AirValve₈ is open. The hydrostatic pressure decreases when the conduit C ascends up D_{Float} to lower depth so the internal pressure in path G is regulated to mimic the hydrostatic pressure.

In FIG. 10 path F valves are open and closed; H2o Valve₁ is closed, is H20 Valve₂ is open, H2o Valve₃ is closed, H2o Valve₄ is open, H2o Valve₅ is closed, is H2o Valve₆ is open, H2o Valve₇ is open, and H2o Valve₈ is closed. The hydrostatic pressure decreases when the conduit C ascends up D_{Float} to lower depth so the internal pressure in path G is regulated to mimic the hydrostatic pressure.

Only a pair of sections of the conduit C are illustrated because the sections are virtually the same and all functions transfers from one section of conduit C to another. The mechanical energy transfer machinery M is a simple machine is not intended to be limited to the illustrated embodiment.

I claim:

1. A structure with means for entry of an impure fluid uses ambient hydrostatic pressure at various depths acting on the impure fluid as an energy source and uses gravitational potential energy converted into mechanical energy in an air space within the structure as another energy source routes the impure fluid through filtration and separation technology to produce streams of fluid with a variety of dissolved solids and routes the streams of fluid to fall within the air space to transfer kinetic energy to machines before exiting the structure where buoyancy further supplies energy to move the streams of fluid to different locations including but not limited to elevated pumped storage thereby delivering both purified fluid such as water and useful energy such as electricity;

2. In combination according to claim 1 the structure is submerged within a body of water with or without impurities on land in a lake or man-made reservoir or the like or in a sea or ocean;

3. In combination according to claim 1 the gravitational potential energy converted into mechanical energy in the air space powers machinery such as pumps, generators, and compressors that radiate wasted energy in the form of heat in their processes that is redirected to filtration and separation machines and other machinery to reduce the demands of another source of energy;

4. Air compressor exhaust and other radiated heat is applied especially but not limited to Multi-stage Flash, Vapor Compression, and Multi-Effect Flash fluid purification technologies to remove or reduce energy and power consumption;

5. In combination according to claim 1 a variety of filtration and separation technology using evaporation, membrane filtration, nano filtration, bacterial filtration, and similar technologies are positioned to send the streams of fluid with higher concentrations of dissolved solids for further processing or immediate discharge back into the body of water at varying depths and in different directions so that the concentrated streams of fluid are diluted prior to being discharged back into the body of water so that the stream of fluid easily dilutes back into normal concentration leaving the ambient ecosystem intact without harm;

6. In combination according to claim 1 the structure when submerged in the body of water is an ocean or sea with living ecosystems will be completely enveloped in a perimeter barrier system in a geometrical configuration that allows the flow of fluid such as seawater inside the barrier system with a velocity and suction equal to or less than the ambient natural flow and the barrier system restricts and filters large organisms and particulate matter without trapping living organisms against the barrier system;

7. In combination according to claim 1 buoyant objects that generate buoyant energy are placed in the streams of fluid contained in conduit outside of the structure pumped up from a greater depth to different locations accelerate the streams of fluid upward and buoyant objects engage machines that transfer the buoyant energy to generate mechanical energy to power machinery such as pumps, compressors, generators, and the like to move the streams of fluid to different locations;

8. In combination according to claim 1 actuated valves open and close streams of fluid in conduit parallel to the streams of fluid being pumped upward in a manner so that hydrostatic pressure can be released in different sections of the conduit to eliminate the need for additional structural support and material without disrupting the constant flow of the streams of fluid;

9. In combination according to claim 1 the streams of fluid being pumped upward that would naturally experience more hydrostatic pressure the higher the streams of fluid ascend will have bypasses and pressure release point junctions;

10. In combination according to claim 1 and according to claim 3 an air compressor is used for the airlock system and the hydraulic system that enables entry and exit from the fluid body to the air space and the air compressor exhaust heat is used for filtration and separation technology using heat to remove dissolved solids from fluids as in Multi-Stage Flash, Multi-Effect Flash and Vapor Compression technology and the like;

11. In combination according to claim 1 pump inlets are positioned at varying depths so that the greater the depth of the pump inlet the lower the power requirements for the pump to access the hydrostatic pressure from the fluid body to push the impure water into a pump that delivers the impure water into membrane filtration technology that uses pressure as the force to separate dissolved solids from the fluid;

12. In combination according to claim 1 finer membranes that remove more dissolved solids are positioned at varying depths so that the greater the depth the greater the hydrostatic pressure is applied from the fluid body to filter more impurities out of the impure fluid;

13. In combination according to claim 1, claim 6, claim 7, and claim 8 the streams of fluid combined with the actuated valves, bypasses, and pressure release junctions have conduit directed up hills, mountains, and various appropriate elevated locations powered by buoyant objects that deposit fluid such as desalted potable water into reservoirs and tanks where the streams of fluid are stored for use and the streams of fluid also become hydroelectric power batteries for future generation as hydropower is captured when the streams of fluid flow down towards end users.
